(19) United States
(12) Patent Application Publication
(10) Pub. No.: US 2014/0203757 A1
(43) Pub. Date: Jul. 24, 2014

(54) DECORATIVE OBJECT WITH A CHARGING DEVICE

(71) Applicants: Svetlana Ibragimova, Boston, MA (US); Aleksei Smetannikov, Cambridge, MA (US)

(72) Inventors: Svetlana Ibragimova, Boston, MA (US); Aleksei Smetannikov, Cambridge, MA (US)

(21) Appl. No.: 14/211,463

(22) Filed: Mar. 14, 2014

(51) Int. Cl. H02J 7/00

(52) U.S. Cl. CPC H02J 7/0044
USPC 320/103

(57) ABSTRACT

An apparatus is presented for using decorative objects having charging capabilities for charging battery operated electronic devices (such as portable and/or wireless/mobile devices) in public places. According to one embodiment, the apparatus for charging battery operated portable electronic devices may comprise a decorative unit, a power unit (power bank) comprising one or more accumulator batteries and configured to recharge one or more battery operated devices external to the apparatus. Such an apparatus may further comprise at least one isolation piece/portion separating the decorative and rechargeable power units and configured to provide electric isolation between the decorative and rechargeable power units.

### TECHNICAL FIELD

This invention relates to charging battery operated electronic devices and more specifically to using a decorative object with charging capabilities.

### BACKGROUND

Mobile electronic devices, such as mobile phones, tablets, laptops and the like have become widespread means of communication. Performance of such devices depends on a battery power source built into them. Failure to quickly charge a low battery device can present a significant inconvenience to a user.

Various public places and businesses such as cafes, restaurants, hair and beauty salons, etc. could, in principle, offer their customers the opportunity to get immediate access to power banks for recharging mobile electronic device. By now, however, known power banks have spread insignificantly among service companies. Additional space required for placing such power recharging banks could be one limiting factor for widespread use. Another limiting factor could be a distortion of aesthetic appeal of the premises that existing power recharging banks cause, as they visually mismatch, e.g., with tableware.

For example, if someone will place such a power recharging bank on tables, coffee tables or similar pieces of furniture in public places, this may distort aesthetic appeal of the premises and reduce a useful surface of the mentioned pieces of furniture thus negatively affecting user experience and attractiveness to customers of corresponding businesses.

### SUMMARY

According to an aspect of the invention, an apparatus, comprising: a decorative unit; a power unit comprising one or more accumulator batteries and configured to recharge one or more battery operated devices external to the apparatus; and at least one isolation piece separating the decorative and rechargeable power units and configured to provide at least electric isolation between the decorative and rechargeable power units.

According further to the aspect of the invention, the at least one isolation piece may be further configured to provide at last in part hermetic isolation between the decorative and power units.

According further to the aspect of the invention, the at least one of the one or more battery operated devices may be a wireless device. Further, the wireless device may be a smart phone, a tablet, a camera-phone, a portable computer, a watch, a global positioning system navigator, a personal digital assistance or a mobile phone.

Still further according to the aspect of the invention, the power unit may be configured to recharge more than one of the one or more battery operated devices simultaneously.

According further to the aspect of the invention, the at least one isolation piece may be a part of the power unit or a part of the decorative unit.

According still further to the aspect of the invention, the power unit may be hermetically sealed.

According yet further still to the aspect of the invention, the decorative unit may be a vase, a napkin holder, a candle holder, an ashtray, or a tray.

Yet still further according to the aspect of the invention, the decorative unit may be attached to the power unit using an adhesive, fasteners, or a spring loading.

Still yet further according to the aspect of the invention, the decorative unit may be configured to be attachable to and detachable from the apparatus.

Still further still according to the aspect of the invention, the power unit may contain an indicator of a charging level of the one or more accumulator batteries.

According further still to the aspect of the invention, the power unit may comprise: one or more power output ports configured to recharge the one or more battery operated devices external to the apparatus; one or more power input ports configured to receive electric power for recharging the one or more accumulator batteries; and a charging control unit configured to facilitate the recharging the one or more battery operated devices external to the apparatus through one or more power output ports, and to facilitate the recharging the one or more accumulator batteries through the one or more power input ports.

According yet further still to the aspect of the invention, the one or more power output ports may comprise one or more of: at least one USB connector, at least one DC jack, at least one magnetic connector, at least one contact plates connector, at least one spring-loaded connector and one or more induction coils. Further, the one or more power input ports may comprise one or more of: at least one USB connector, at least one DC jack, at least one magnetic connector, at least one contact plates connector, at least one spring-loaded connector and one or more induction coils. Still further, one or more of the input and output ports may be wireless.

According still yet further to the aspect of the invention, the at least one isolation piece may be made of a plastic, ceramic, wood or glass.

According still yet further still to the aspect of the invention, the at least one of the one or more accumulator batteries may be a replaceable battery, so that after being removed from the apparatus the replaceable battery is replaced instantly with another already fully charged accumulator battery. Then, the power unit may comprises: one or more power output ports configured to recharge the one or more battery operated devices external to the apparatus, and a charging control unit configured to facilitate said recharging the one or more battery operated devices external to the apparatus through one or more power output ports using the removable accumulator battery.

### DESCRIPTION OF DRAWINGS

FIG. 1 is a general block diagram of an apparatus having a decorative object and charging capabilities, according to one embodiment;

FIGS. 2a-2c are different views of an exemplary apparatus with a vase as a decorative unit, including a side view shown in FIG. 2a and bottom views with and without cover shown in FIGS. 2b and 2c, respectively;

FIGS. 3a-3e are different views of an exemplary apparatus with a napkin holder as a decorative unit, including two three-dimensional views shown in FIGS. 3a-3b, a front view shown in FIG. 3c and bottom views with and without cover of the power unit shown in FIGS. 3d and 3e, respectively; and

FIG. 4 is a view of an exemplary apparatus with a vase as a decorative unit and having an input contact plates connector designed to connect to output connectors of a charging station.

### DESCRIPTION

An apparatus is presented for using decorative objects having charging capabilities for charging battery operated electronic devices (such as portable and/or wireless/mobile devices) in public places. According to one embodiment, the apparatus for charging battery operated portable electronic devices may comprise a decorative unit, a power unit (power bank) comprising one or more accumulator batteries and configured to recharge one or more battery operated devices external to the apparatus. Such an apparatus may further comprise at least one isolation piece/portion separating the decorative and rechargeable power units and configured to provide electric isolation between the decorative and rechargeable power units.

Moreover, the isolation piece(s) may also provide hermetic isolation (at least in part) between the decorative and rechargeable power units. The isolation piece may be made of plastic, ceramic, glass or similar materials and their combinations. Also, the isolation piece may be a part of the power unit, or a part of the decorative unit. The decorative unit may be implemented as a vase (for example, for placing flowers) a napkin holder, a candle holder, an ashtray, a tray and the like. The decorative unit having a shape of container may be used for storage of physical objects such as flowers, napkins, candles, etc.

The decorative unit may be attached to the power unit, for example, using an adhesive, fasteners or a spring loading. Also the decorative unit may be attachable to and detachable from the apparatus (e.g., for cleaning) According to a further embodiment, the decorative unit can comprise at least one receiving structure for battery operated devices external to the apparatus for recharging.

Furthermore, the at least one of the one or more battery operated devices may be (but are not limited to) a portable device, a mobile/wireless device such as a smart phone, a tablet, a camera-phone, a portable computer, a watch, a global positioning system (GPS) navigator, a personal digital assistance (PDA), a mobile phone and the like.

According to further embodiments, the power unit may further comprise: one or more power output ports configured to recharge the one or more battery operated devices external to the apparatus and one or more power input ports configured to receive electric power for recharging the one or more accumulator batteries. It can further include a charging control unit configured to facilitate the recharging the one or more battery operated devices external to the apparatus through one or more power output ports, and to facilitate the recharging the one or more accumulator batteries through the one or more power input ports. It is further noted that the power unit may be configured to recharge more than one of the one or more battery operated devices simultaneously. Also the power unit may be hermetically sealed, e.g., using hermetic input and output connectors.

According to a further exemplary embodiment, each of the one or more power output ports and one or more power input ports may comprise one or more of: at least one USB connector, at least one DC jack (e.g., 1.7-1.3 mm), at least one magnetic connector, at least one contact plates connector, at least one spring-loaded connector (for wired connection) and one or more induction coils (for wireless connection). Therefore any of the input and output ports may be a wired port (using USB, DC jack connector, etc.) or a wireless port (e.g., using one or more induction coils) to transfer electric power in and from the apparatus.

Moreover, the power unit may contain an indicator of a charging level of the one or more batteries and may be further configured to implement over-charge protection, over-discharge protection, short circuit protection, overheating protection, multiple battery charging balancing, and/or charging voltage variation functions.

According to a further embodiment, at least one of the one or more accumulator batteries may be a replaceable battery, so that after being removed from the apparatus the removed accumulator battery can be charged independently and placed back to the apparatus. Alternatively, the removed discharged accumulator battery may be immediately replaced by another already fully charged accumulator battery. The removed accumulator battery may be charged later on using a separate charging station outside of the public facilities In this embodiment, having one or more power input ports for recharging the one or more accumulator batteries may not be needed and is optional as an alternative way for recharging the accumulator battery without removing it from the recharging apparatus.

One of the objectives of using embodiments described herein is to provide businesses/service companies with the opportunity to place (install) rechargeable units (power banks) without having them to take up an extra space and distorting the aesthetic integrity of the public area. The built-in battery (or batteries) in the power bank can enable users to charge electronic devices without a presence of immediate connection to an electrical network, thus, without a need for cables connecting the charging device to a nearest wall power socket. This way of charging does not distort the aesthetic integrity of the premises. The design of the charging apparatus combined with and/or in a shape of the decorative object, like a vase, a candle holder, a napkin holder, an ashtray, a tray and the like, will allow maintaining functionality of the decorative object. This will allow service companies to replace conventional vases, napkin holders and the like located on tables, coffee tables or similar pieces of furniture, with the apparatus, without a need for extra space. Readily available in public places and pleasantly looking power charging apparatus will increase comfort and reduce stress of users of mobile electronic devices.

It should be further understood that the power unit (or power bank) itself can be an electro-insulating part and together with isolation properties (both electrical and hermetic/waterproof) of the isolated pieces/portions described herein may ensure electrical safety of the whole apparatus in presence of liquid or other electro-conductive materials. The described apparatus with decorative and power units is autonomous in a way that, in order to perform charging, it does not require immediate connection to a power source, as it is capable of energy storage. Furthermore, mobile devices can connect to the at least one output port via cables compatible with all known types of phones and other mobile electronic devices. The apparatus can be provided with a set of cables for possible mobile devices to be recharges. In case the output port is designed in a form of induction coils, cables are not required as charging nay be carried out wirelessly. To maintain autonomous its charging ability it is necessary to periodically recharge the apparatus. It may be charged from a special charging station through the input port. The charging station can allow parallel charging one or more claimed apparatuses.

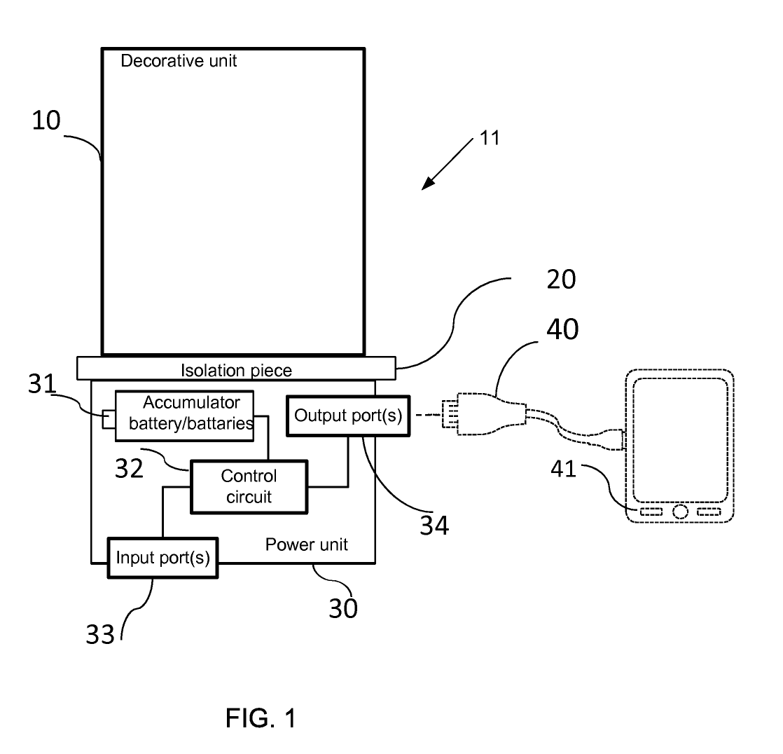

FIGS. 1-4 below demonstrate various implementations scenarios based on exemplary embodiments.

Referring to FIG. 1, a general block diagram of an apparatus 11 is shown, according to one embodiment described herein. The apparatus 11 comprises a decorative unit 10, a power unit 30 having capabilities for charging external battery electronic device(s) 41 using an external connector 40, and at least one isolation piece 20 separating the decorative and rechargeable power units and configured to provide at least electric isolation and optionally some hermetic isolation between the decorative and rechargeable power units 10 and 30, respectively. The power unit 30 comprises one or more accumulator batteries 31, one or more power output ports 34 (configured to recharge the one or more battery operated devices external to the apparatus 11), one or more power input ports 33 (configured to receive electric power for recharging the one or more accumulator batteries), and a control circuit configured to facilitate the recharging the one or more battery operated devices external to the apparatus through the corresponding one or more power output ports, and to facilitate the recharging the one or more accumulator batteries through the one or more power input ports.

The power unit 30 may be configured to recharge the battery when the input 33 port is connected with a charging station. The power unit 30 may be also configured to provide current to the output connector 34 when a battery operated external apparatus 40 is connected to it. The circuit 32 can control conventional functionalities such as overcharge, over-discharge, overheat and short circuit protection functions.

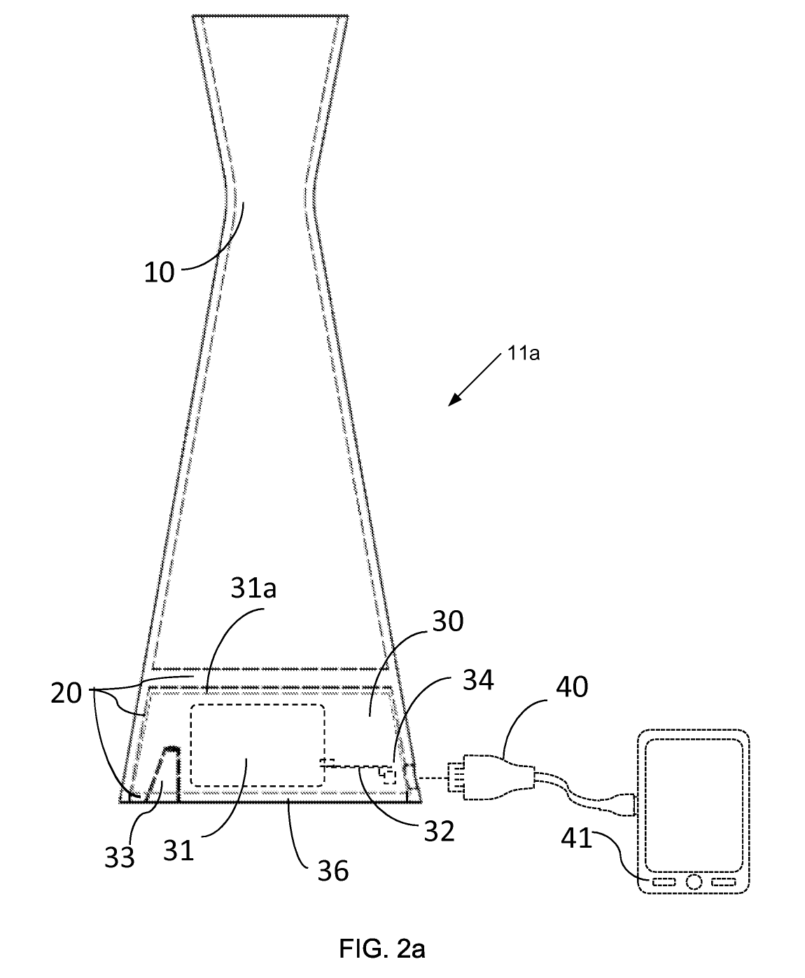

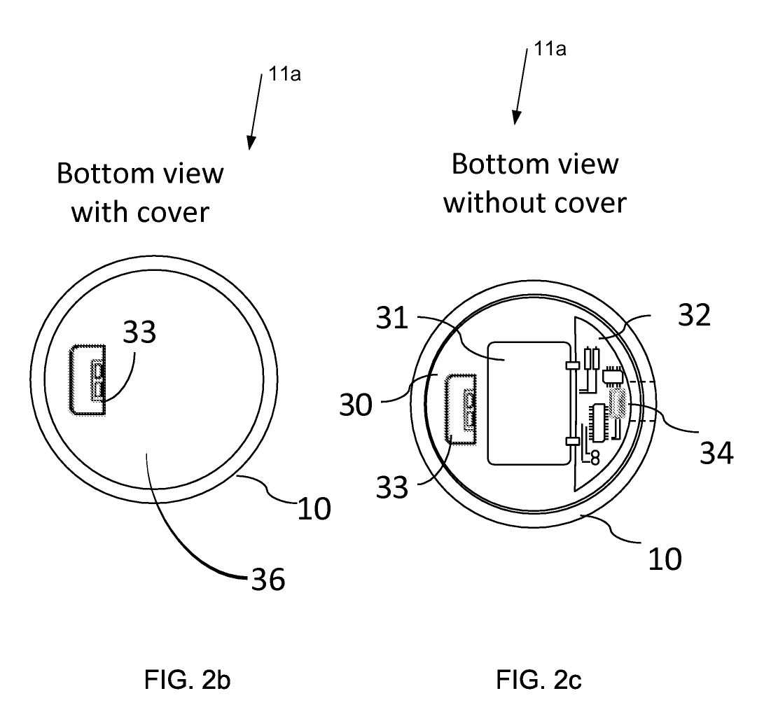

A more detailed description of the units 10 and 30, and of the isolation piece 20 is provided in the text above and further demonstrated in examples shown in FIGS. 2-4 below. FIGS. 2-4 have identical numerical designation of elements similar to those shown in FIG. 1.

Referring to FIGS. 2a-2c, an exemplary apparatus 11 a with a vase as a decorative unit 10 is shown, including a side view shown in FIG. 2a and bottom views with and without cover 36 shown in corresponding FIGS. 2b and 2c. FIG. 2a shows that one of insulation pieces 20 which is a part of the vase 10 represented by a porcelain diaphragm inside the vase. Other insulation pieces are parts of the power unit 30, in particular, a plastic shell 30a of the power unit 30, as well as a plastic cover 36 of the power unit 30. These insulation pieces provide electrical and hermetic insulation between the power unit 30 and a liquid that may be stored inside the decorative unit (vase) 10.

Moreover, in FIG. 2a, the decorative unit 10 is attached to the power unit 30 using an adhesive. The power unit comprises a battery 31, a charging and discharging circuit 32, an input port 33 comprising one contact plates DC connector and providing an additional hermetic insulation, and an output port 34 comprising one USB type-A connector.

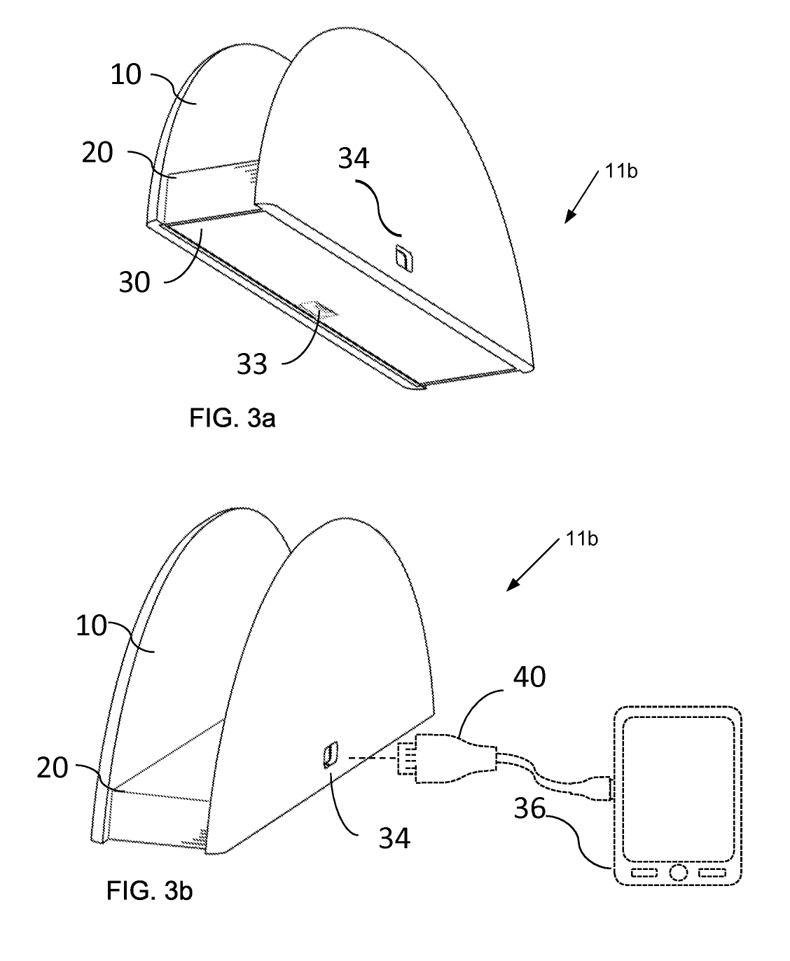

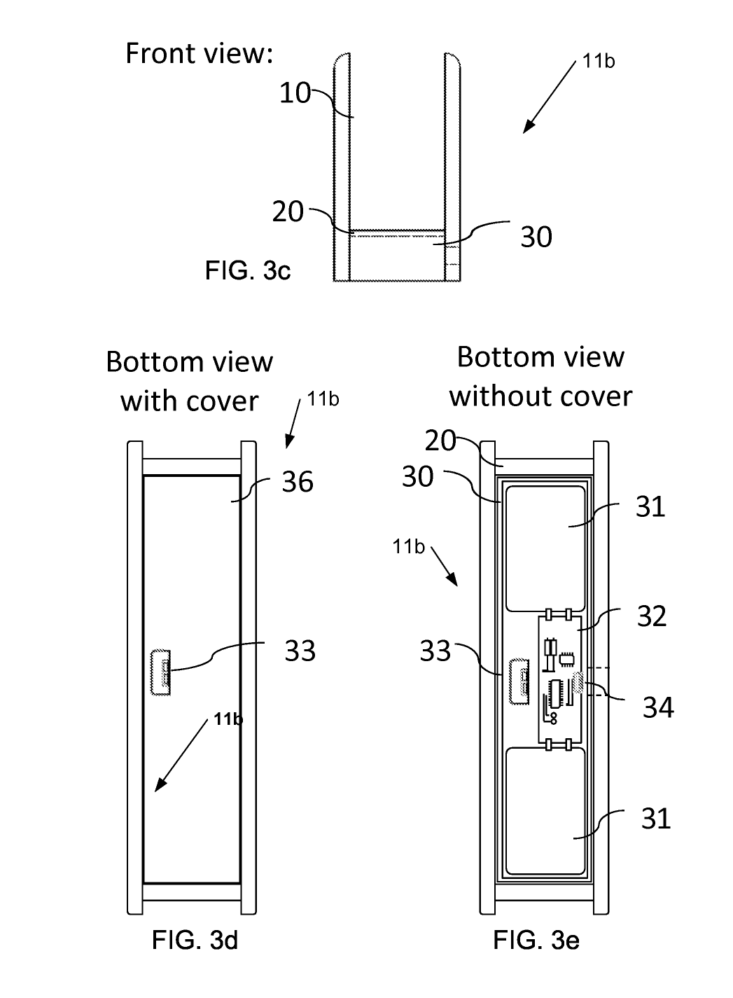

Referring to FIGS. 3a-3e, an exemplary apparatus 11b with a napkin holder as a decorative unit 10 is shown, including two three-dimensional views shown in FIGS. 3a-3b, a front view shown in FIG. 3c and bottom views with and without cover 36 of the power unit 30 shown in corresponding FIGS. 3d and 3e. The power unit 30 comprises two batteries 31. One of insulation pieces 20 is a part of the decorative unit 10 and another insulating piece 20 is a part of the power unit 30 as shown in FIGS. 3d and 3e. Other elements are equivalent to the corresponding elements shown in FIGS. 2a-2c.

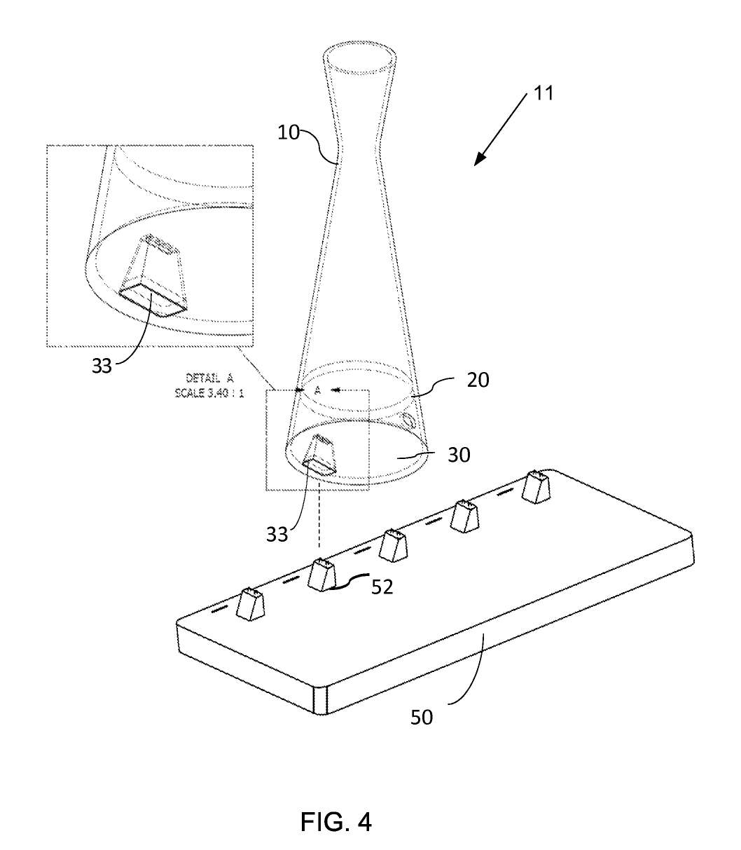

Referring to FIG. 4, an exemplary apparatus 11 with a vase as a decorative unit 10 having input contact plates DC connector 33 designed to connect to output connectors 52 of a charging station 50 is shown. In this example, the power unit 30 is hermetically sealed, and the power input port 33 is hermetically insulated and connectable to a custom spring-loaded output connector 52 of the charging station 50.

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is to be understood that the foregoing description is intended to illustrate and not to limit the scope of the invention, which is defined by the scope of the appended claims. Other embodiments are within the scope of the following claims.

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof

It is further to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

What is claimed is:

1. An apparatus, comprising:
a decorative unit;
a power unit comprising one or more accumulator batteries and configured to recharge one or more battery operated devices external to the apparatus; and
at least one isolation piece separating the decorative and rechargeable power units and configured to provide at least electric isolation between the decorative and rechargeable power units.

2. The apparatus of claim 1, wherein the at least one isolation piece is further configured to provide at last in part hermetic isolation between the decorative and power units.

3. The apparatus of claim 1, wherein the at least one of the one or more battery operated devices is a wireless device.

4. The apparatus of claim 2, wherein the wireless device is a smart phone, a tablet, a camera-phone, a portable computer, a watch, a global positioning system navigator, a personal digital assistance or a mobile phone.

5. The apparatus of claim 1, wherein the power unit is configured to recharge more than one of the one or more battery operated devices simultaneously.

6. The apparatus of claim 1, wherein the at least one isolation piece is a part of the power unit.

7. The apparatus of claim 1, wherein the at least one isolation piece is a part of the decorative unit.

8. The apparatus of claim 1, wherein the power unit is hermetically sealed.

9. The apparatus of claim 1, wherein the decorative unit is a vase.

10. The apparatus of claim 1, wherein the decorative unit is a napkin holder.

11. The apparatus of claim 1, wherein the decorative unit is a candle holder, an ashtray, or a tray.

12. The apparatus of claim 1, wherein the decorative unit is attached to the power unit using an adhesive, fasteners, or a spring loading.

13. The apparatus of claim 1, wherein the decorative unit is configured to be attachable to and detachable from the apparatus.

14. The apparatus of claim 1, wherein the power unit contains an indicator of a charging level of the one or more accumulator batteries.

15. The apparatus of claim 1, wherein the power unit comprises:
one or more power output ports configured to recharge the one or more battery operated devices external to the apparatus;
one or more power input ports configured to receive electric power for recharging the one or more accumulator batteries; and
a charging control unit configured to facilitate said recharging the one or more battery operated devices external to the apparatus through one or more power output ports, and to facilitate said recharging the one or more accumulator batteries through the one or more power input ports.

16. The apparatus of claim 15, wherein the one or more power output ports comprise one or more of: at least one USB connector, at least one DC jack, at least one magnetic connector, at least one contact plates connector, at least one spring-loaded connector and one or more induction coils.

17. The apparatus of claim 15, wherein the one or more power input ports comprise one or more of: at least one USB connector, at least one DC jack, at least one magnetic connector, at least one contact plates connector, at least one spring-loaded connector and one or more induction coils.

18. The apparatus of claim 1, wherein one or more of the input and output ports are wireless.

19. The apparatus of claim 1, wherein the at least one isolation piece is made of a plastic, ceramic, wood or glass.

20. The apparatus of claim 1, wherein the decorative unit comprises at least one receiving structure for one of the one or more battery operated devices external to the apparatus for recharging.

21. The apparatus of claim 1, wherein at least one of the one or more accumulator batteries is a replaceable battery, so that after being removed from the apparatus the replaceable battery is replaced instantly with another already fully charged accumulator battery.

22. The apparatus of claim 21, wherein the power unit comprises:
one or more power output ports configured to recharge the one or more battery operated devices external to the apparatus, and
a charging control unit configured to facilitate said recharging the one or more battery operated devices external to the apparatus through one or more power output ports using the removable accumulator battery.
